(19) United States
(12) Patent Application Publication
(10) Pub. No.: US 2023/0119156 A1
(43) Pub. Date: Apr. 20, 2023

(54) METHODS FOR STRENGTH MEASUREMENT

(71) Applicant: CHENGDU FIT-FUTURE TECHNOLOGY CO., LTD., Chengdu (CN)

(72) Inventors: Bowen ZHANG, Chengdu (CN); Weitao XI, Chengdu (CN); Yifan YUAN, Chengdu (CN); Qiang FU, Chengdu (CN); Tianguang TANG, Chengdu (CN)

(73) Assignee: CHENGDU FIT-FUTURE TECHNOLOGY CO., LTD., Chengdu (CN)

(21) Appl. No.: 18/045,460

(22) Filed: Oct. 10, 2022

(30) Foreign Application Priority Data
Oct. 14, 2021 (CN) 202111198959.7

(51) Int. Cl. G01L 5/00

(52) U.S. Cl. CPC G01L 5/0033

(57) ABSTRACT

The present disclosure provides a method for strength measurement, including: obtaining action information at one or more rounds corresponding to one or more rounds of test actions completed by a user to be tested on a strength-type intelligent fitness device; and updating a measurement parameter of the strength-type intelligent fitness device based on the action information at the one or more rounds. The method further comprises determining a next round of a test action based on the updated measurement parameter; and calculating and obtaining maximum strength information of the user to be tested based on the action information during N rounds of the test actions.

### CROSS-REFERENCE TO RELATED APPLICATIONS

This application claims priority to Chinese Patent Application No. 202111198959.7, filed on Oct. 14, 2021, the contents of which are hereby incorporated by reference to its entirety.

### TECHNICAL FIELD

The present disclosure relates to the field of intelligent fitness, and in particular, to a method for strength measurement.

### BACKGROUND

The working principle of a strength-type intelligent fitness device includes that: a strength-type intelligent fitness device includes a motor, a differential, support arms, a pull rope, and corresponding controllers, circuits, and accessories. A belt is connected between a motor output shaft and the differential, one end of the pull rope is connected to the differential, and the other end of the pull rope is connected to a pull ring or other fitness accessories after traveling along the support arms. When exercising, a user may exercise by pulling the pull rope or using the support arms. The pull rope drives the motor to move through the differential and the belt. When the motor is energized, the output torque is the resistance, and the user needs to overcome the output torque of the motor when pulling the pull rope, thus realizing the purpose of strength training for the user.

The exercise method of the strength-type intelligent fitness device includes that the user needs to overcome the output torque of the motor for the strength training. The strength level of each user is different, so training with a uniform strength parameter is not suitable for all users. Therefore, it is necessary to measure a strength level of the user and then exercise according to the actual strength level of the user, thereby achieving a safe and efficient exercise.

### SUMMARY

In order to realize the measurement of a strength level of a user, the present disclosure provides a method for strength measurement.

To achieve the above purpose, one or more embodiments of the present disclosure provide a method for strength measurement. The method comprises: obtaining action information at one or more rounds corresponding to one or more rounds of test actions completed by a user to be tested on a strength-type intelligent fitness device; and updating a measurement parameter of the strength-type intelligent fitness device based on the action information at the one or more rounds.

In some embodiments, the method further comprises: determining a next round of a test action of the strength-type intelligent fitness device based on the updated measurement parameter.

In some embodiments, the updating the measurement parameter of the strength-type intelligent fitness device based on the action information at the one or more rounds comprises: determining a measurement parameter at a current round based on an initial measurement parameter; or determining the measurement parameter at the current round based on action information at a previous round. In some embodiments, the action information at each round at least comprises: a maximum pulling force and a maximum speed during each round of the test actions completed by the user to be tested; and the determining the measurement parameter at the current round based on the action information at the previous round includes: determining the measurement parameter at the current round based on the maximum pulling force and the maximum speed of the action information at the previous round.

The principle of the method includes: measuring the strength information of a user based on a strength-type intelligent fitness device, through multiple measurements and, after each measurement, updating the measurement parameter of the next round of strength-type intelligent fitness device based on a previous strength measurement result, gradually approaching the real maximum strength parameter of the user, and finally accurately obtaining the maximum strength information of the user.

The method may obtain the real maximum strength information of the user, and the process of obtaining is gradually approaching, rather than using estimates or larger strengths to try, which has high security and may not exceed the strength that the user may bear. After measuring and obtaining the maximum strength of the user, the strength-type intelligent fitness device may use the maximum strength of the user to exercise during subsequent exercise, which may ensure the efficiency and effect of the exercise.

In some embodiments, a pulling force of the user to be tested during a test action at the m-th round is F, wherein:

F=f₀+k₁×max(0,vₘ−v₀)

where, f₀ denotes an initial pulling force during the test action at the m-th round, v₀ denotes an initial speed during the test action at the m-th round, vₘ denotes a real-time speed during the test action at the m-th round, k₁ denotes a proportional parameter, and m is greater than or equal to 1 and less than or equal to 3.

The pulling force in this method is a constant initial pulling force in the initial stage when the speed is low, and then gradually increases pulling force with the speed increase. The purpose of this is that pulling force is small in the initial stage so as to prevent the user from being injured by exerting strength at the beginning.

In some embodiments, the determining the measurement parameter at the current round based on the action information at the previous round comprises: updating the initial pulling force f₀ during the test action at the m-th round, the initial speed v₀ during the test action at the m-th round, and the proportional parameter k₁ based on the action information of the test action at the (m−1)-th round, wherein m is greater than 1 and less than or equal to 3.

In some embodiments, the determining the measurement parameter at the current round based on the action information at the previous round comprises: updating the initial pulling force f₀ during the test action at the m-th round based on a maximum speed vₘₐₓ and a maximum pulling force fₘₐₓ during the test action at the (m−1)-th round; updating the initial speed v₀ during the test action at the m-th round based on a count of completed rounds of the test actions; and updating the proportional parameter k₁ based on the maximum pulling force fₘₐₓ during the test action at the (m−1)-th round, the initial pulling force f₀ during the test action at the m-th round, the initial speed v₀ during the test action at the m-th round, and an ideal speed.

In some embodiments, the initial pulling force f₀ during the test action at the m-th round is updated by the following formula:

$${f}_{0} = {k}_{f} \times {f}_{max}$$

$${k}_{f} = \{ \begin{matrix}0.6 if {v}_{max} is less than or equal to 0.5 \\ 0.5 if {v}_{max} is greater than 0.5 and less than or equal to 0.8 \\ 0.4 if {v}_{max} is greater than 0.8 and less than or equal to 1.2 \\ 0.4 if {v}_{max} is greater than 1.2\end{matrix}$$

the initial speed v₀ during the test action at the m-th round is updated by the following formula:

$${v}_{0} = \{ \begin{matrix}0.3 if T is equal to 1 \\ 0.2 if T i s equal to 2 \\ 0.1 if T is greater than or equal to 3\end{matrix}$$

wherein T is the count of the completed rounds of the test actions; and
the proportional parameter k₁ is updated by the following formula:

k₁=(fₘₐₓ−f₀)/(goalvel−v₀)

wherein goalvel denotes the ideal speed.

In some embodiments, the method further comprises: determining maximum strength information of the user to be tested based on the action information at the one or more rounds. In some embodiments, the action information at each round at least includes: parameter information corresponding to each round of the test actions; and the determining maximum strength information of the user to be tested based on the action information at the one or more rounds includes: obtaining the maximum strength information of the user to be tested which is calculated based on the parameter information corresponding to the multiple rounds of the test actions.

In some embodiments, action types of each round of the test actions includes at least two action types; and the method further includes: obtaining at least two maximum strength information of the user to be tested based on the action information corresponding to the test actions of the at least two action types; and determining comprehensive maximum strength information of the user to be tested based on the at least two maximum strength information.

In some embodiments, the determining the maximum strength information of the user to be tested based on the action information at the one or more rounds comprises: obtaining the maximum strength information of the user to be tested by calculating the action information at the one or more rounds based on a multivariate regression model.

In some embodiments, the determining the maximum strength information of the user to be tested based on the action information at the one or more rounds comprises: calculating the maximum strength information of the user to be tested based on a maximum speed, a maximum pulling force, a maximum power, an average speed, and an average power during N rounds of the test actions, wherein N is greater than or equal to 3.

In some embodiments, the maximum strength information of the user to be tested is denoted as RM, which is determined by the following formula:

RM=max_vel×k_{max_vel} max_force×k_{max_force} max_power×k_{max_power}+average_power×k_{average_power} average_vel×k_{average_vel}

where the maximum speed during the N rounds of the test actions is denoted as max_vel, the maximum pulling force during the N rounds of the test actions is denoted as max_force, the maximum power during the N rounds of the test actions is denoted as max_power, the average speed during the N rounds of the test actions is denoted as average_vel, the average_power during the N rounds of the test actions is denoted as average_power, k_{max_vel} denotes a multivariate regression coefficient of max_vel, k_{max_force} denotes a multivariate regression coefficient of max_force, k_{max_power} denotes a multivariate regression coefficient of max_power, k_{average_power} denotes a multivariate regression coefficient of average_power, and k_{average_vel} denotes a multivariate regression coefficient of average_vel.

One or more embodiments of the present disclosure provide a device for strength measurement. The device comprises: at least one storage medium, wherein the storage medium includes a set of instructions; at least one processor communicating with the at least one storage medium, wherein when executing the set of instructions, the at least one processor is configured to cause the device to: obtain action information at one or more rounds corresponding to one or more rounds of test actions completed by a user to be tested on a strength-type intelligent fitness device; and update a measurement parameter of the strength-type intelligent fitness device based on the action information at the one or more rounds.

In some embodiments, the device is further used to determine a next round of a test action of the strength-type intelligent fitness device based on the updated measurement parameter.

In some embodiments, the updating the measurement parameter of the strength-type intelligent fitness device based on the action information at the one or more rounds comprises: determining a measurement parameter at a current round based on an initial measurement parameter; or determining the measurement parameter at the current round based on action information at a previous round. The action information at each round at least comprises: a maximum pulling force and a maximum speed during each round of the test actions completed by the user to be tested.

In some embodiments, a pulling force of the user to be tested during a test action at the m-th round is F, wherein:

F=f₀+k₁×max(0,vₘ−v₀)

where, f₀ denotes an initial pulling force during the test action at the m-th round, v₀ denotes an initial speed during the test action at the m-th round, vₘ denotes a real-time speed during the test action at the m-th round, k₁ denotes a proportional parameter, and m is greater than or equal to 1 and less than or equal to 3.

In some embodiments, the determining the measurement parameter at the current round based on the action information at the previous round comprises: updating the initial pulling force f₀ during the test action at the m-th round, the initial speed v₀ during the test action at the m-th round, and the proportional parameter k₁ based on the action information of the test action at the (m−1)-th round, wherein m is greater than 1 and less than or equal to 3.

In some embodiments, the determining the measurement parameter at the current round based on the action information at the previous round comprises: updating the initial pulling force f₀ during the test action at the m-th round based on a maximum speed vₘₐₓ and a maximum pulling force fₘₐₓ during the test action at the (m−1)-th round; updating the initial speed v₀ during the test action at the m-th round based on a count of completed rounds of the test actions; and updating the proportional parameter k₁ based on the maximum pulling force fₘₐₓ during the test action at the (m−1)-th round, the initial pulling force f₀ during the test action at the m-th round, the initial speed v₀ during the test action at the m-th round, and an ideal speed.

In some embodiments, the initial pulling force f₀ during the test action at the m-th round is updated by the following formula:

$${f}_{0} = {k}_{f} \times {f}_{max}$$

$${k}_{f} = \{ \begin{matrix}0.6 if {v}_{max} is less than or equal to 0.5 \\ 0.5 if {v}_{max} is greater than 0.5 and less than or equal to 0.8 \\ 0.4 if {v}_{max} is greater than 0.8 and less than or equal to 1.2 \\ 0.4 if {v}_{max} is greater than 1.2\end{matrix}$$

the initial speed v₀ during the test action at the m-th round is updated by the following formula:

$${v}_{0} = \{ \begin{matrix}0.3 if T is equal to 1 \\ 0.2 if T i s equal to 2 \\ 0.1 if T is greater than or equal to 3\end{matrix}$$

wherein T is the count of the completed rounds of the test actions; and the proportional parameter k₁ is updated by the following formula:

k₁=(fₘₐₓ−f₀)/(goalvel−v₀)

wherein goalvel denotes the ideal speed.

In some embodiments, the device for strength measurement is further used to: determine maximum strength information of the user to be tested based on the action information at the one or more rounds. In some embodiments, the determining the maximum strength information of the user to be tested based on the action information at the one or more rounds comprises: obtaining the maximum strength information of the user to be tested by calculating the action information at the one or more rounds based on a multivariate regression model. In some embodiments, the determining the maximum strength information of the user to be tested based on the action information at the one or more rounds comprises: calculating the maximum strength information of the user to be tested based on a maximum speed, a maximum pulling force, a maximum power, an average speed, and an average_power during N rounds of the test actions, wherein N is greater than or equal to 3.

In some embodiments, the maximum strength information of the user to be tested is denoted as RM, which is determined by the following formula:

RM=max_vel×k_{max_vel} max_force×k_{max_force} max_power×k_{max_power}+average_power×k_{average_power} average_vel×k_{average_vel}

where the maximum speed during the N rounds of the test actions is denoted as max_vel, the maximum pulling force during the N rounds of the test actions is denoted as max_force, the maximum power during the N rounds of the test actions is denoted as max_power, the average speed during the N rounds of the test actions is denoted as average_vel, the average_power during the N rounds of the test actions is denoted as average_power, k_{max_vel} denotes a multivariate regression coefficient of max_vel, k_{max_force} denotes a multivariate regression coefficient of max_force, k_{max_power} denotes a multivariate regression coefficient of max_power, k_{average_power} denotes a multivariate regression coefficient of average_power, and k_{average_vel} denotes a multivariate regression coefficient of average_vel.

One or more technical schemes provided by the present disclosure have at least the following technical effects or advantages. This method can safely, efficiently, and accurately measure the maximum strength information of the user.

### BRIEF DESCRIPTION OF THE DRAWINGS

The accompanying drawings described herein are used to provide further understanding of the embodiments of the present disclosure, and constitute a part of the present disclosure, but do not constitute a limitation to the embodiments of the present disclosure;

FIG. 1 is a schematic flowchart illustrating a method for strength measurement;

FIG. 2 is a schematic diagram illustrating the relationship between a pulling force and a speed of the present disclosure;

FIG. 3 is a schematic diagram illustrating an interval distribution of action and speed in the strength training;

FIG. 4 is a schematic diagram illustrating an ideal speed point;

FIG. 5 is a schematic diagram of the F-v curve of actions at three rounds.

### DETAILED DESCRIPTION

In order to be able to understand the above objects, features, and advantages of the present disclosure more clearly, the present disclosure may be further described in detail below with reference to the accompanying drawings and specific embodiments. It should be noted that the embodiments of the present disclosure and the features in the embodiments may be combined with each other under the condition that they do not conflict with each other.

In the following description, numerous specific details are set forth in order to provide a thorough understanding of the present disclosure. However, the present disclosure may be practiced in other ways than those described herein. Therefore, the protection scope of the present disclosure is not limited by the specific embodiments disclosed below.

As shown in the present disclosure and the claims, unless the context clearly suggests exceptional circumstances, the words “a”, “an” and/or “the” do not specifically refer to the singular, but may also include the plural. In general, the terms “comprise,” “comprises,” and/or “comprising,” “include,” “includes,” and/or “including,” merely prompt to include steps and elements that have been clearly identified, and these steps and elements do not constitute an exclusive listing. The methods or devices may also include other steps or elements.

### Embodiment 1

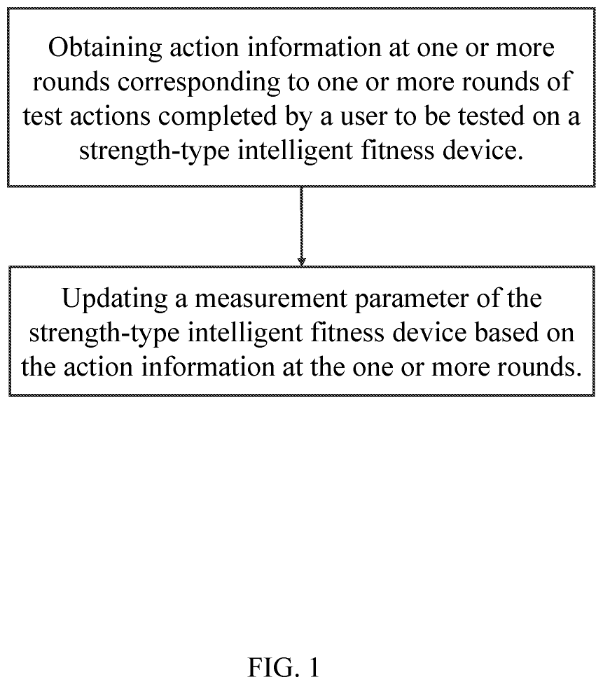

Please refer to FIG. 1, FIG. 1 is a schematic flowchart illustrating a method for strength measurement. The method for strength measurement of Embodiment 1 of the present disclosure includes: obtaining action information at one or more rounds corresponding to one or more rounds of test actions completed by a user to be tested on a strength-type intelligent fitness device; and updating a measurement parameter of the strength-type intelligent fitness device based on the action information at the one or more rounds.

The user to be tested refers to an operator who performs test actions on a fitness device. For example, the user to be tested may be a fitness trainee or a fitness coach.

The test actions refer to actions conducted by the user to be tested to exercise when operating the fitness device. In some embodiments, a test action includes but is not limited to a pull-down, a strength press, a bench press, a deadlift, or the like. For example, when the user to be tested is training back muscles and upper limbs, the test action may be a pull-down. As another example, when the user to be tested is training the lower back muscles and waist gluteus, the test action may be a deadlift.

The action information is information that may reflect the features of the test actions. For example, the action information may be the pulling force, speed, acceleration, etc., used by the user to be tested in completing the test action at each round. In some embodiments, the action information may be the maximum speed or the maximum pulling force of the test action.

In some embodiments, the measurement parameter of the current round may be determined based on the initial measurement parameter. Or the measurement parameter of the current round may be determined based on the action information of the previous round to update the measurement parameter of the strength-type intelligent fitness device.

A measurement parameter refers to a reference action parameter of the user during fitness. The measurement parameter of the user during the first test action is the initial measurement parameter. In some embodiments, the measurement parameter may be adjusted according to the action information of the previous round of the user. For example, an initial measurement parameter may be set as a small value in the test action of the first round to avoid the phenomenon of being unable to pull. After each round of the test actions are completed, the measurement parameter is updated according to the action information (for example, the pulling force value) of this action.

In some embodiments, the action information may at least include: maximum pulling force and maximum speed when the user to be tested completes each round of the test actions. In some embodiments, the measurement parameter of the current round may be determined based on the maximum pulling force and the maximum speed corresponding to the action information of the previous round.

In some embodiments, the method for strength measurement may also include determining a test action at a next round of the strength-type intelligent fitness device based on the updated measurement parameter.

The principle of the method includes: measuring the strength information of a user based on a strength-type intelligent fitness device, through multiple measurements and, after each measurement, updating the measurement parameter of the next round of the strength-type intelligent fitness device based on a previous strength measurement result, gradually approaching the real maximum strength parameter of the user, and finally accurately obtaining the maximum strength information of the user.

In the embodiments of the present disclosure, this method can achieve setting and adjustment of the value of the initial measurement parameter correspondingly according to the group types of the user and the strength-type intelligent fitness device, and the specific value of the initial measurement parameter is not limited in the present disclosure.

Compared with an estimated maximum strength information of the user or obtaining maximum strength information of the user by letting the user try for himself/herself, the maximum strength information of the user obtained by using the method is gradually approaching the real maximum strength information of the user, which has high security and may not exceed the strength that the user may bear. After measuring and obtaining the maximum strength of the user, the strength-type intelligent fitness device may use the maximum strength of the user to exercise during subsequent exercise, which can ensure the efficiency and effect of the exercise.

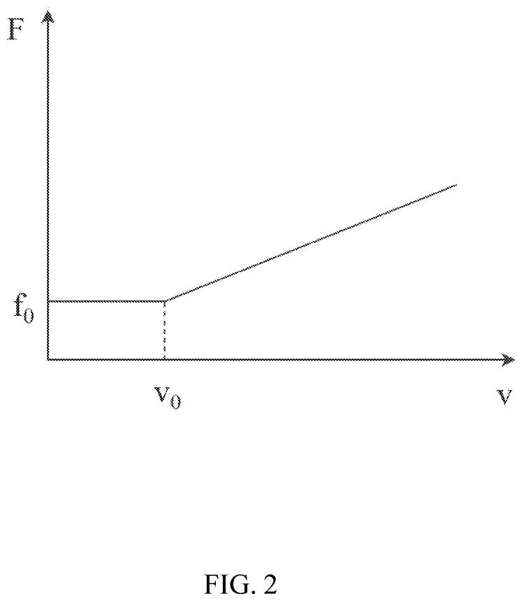

In this embodiment, during the evaluation process, an isokinetic mode may be used to calculate the pulling force. Please refer to FIG. 2, FIG. 2 is a schematic diagram illustrating the relationship between a pulling force and a speed of the present disclosure, wherein the abscissa is the speed, the ordinate is the pulling force, and the pulling force increases with the increase of the speed. The pulling force of the user to be tested during a test action at the m-th round is F, wherein

F=f₀+k₁×max(0,vₘ−v₀)

where, f₀ denotes an initial pulling force during the test action at the m-th round, v₀ denotes an initial speed during the test action at the m-th round, vₘ denotes a real-time speed during the test action at the m-th round, k₁ denotes a proportional parameter, and m is greater than or equal to 1 and less than or equal to 3.

The pulling force in the initial stage when the speed is low is a constant initial pulling force, and then gradually increases with the speed increase. The purpose of this is that pulling force is small in the initial stage so as to prevent the user from being injured by exerting strength at the beginning.

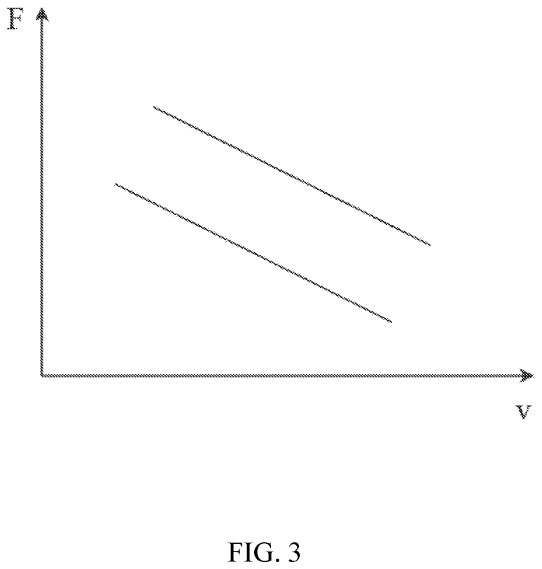

Please refer to FIG. 3, FIG. 3 is a schematic diagram illustrating an interval distribution of action and speed in strength training. In strength training, the speed of the action may decrease with the increase of the load of the fitness device. For the same action, although the strength levels of different users are different, the power-speed distribution may generally be in the parallel lines in FIG. 3. Close to the upper boundary of the parallel lines indicates that the user can achieve higher speed at the same strength than others, or greater strength at the same speed, which further indicates that the strength level of the user is high; approaching the lower boundary indicates that the strength level of the user is low.

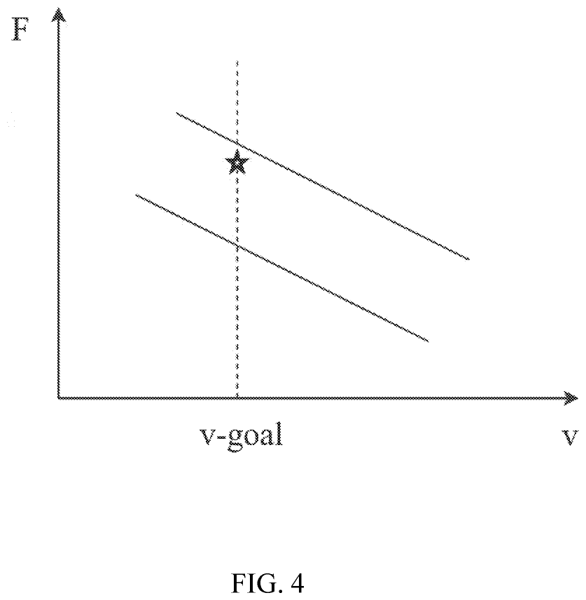

Please refer to FIG. 4, FIG. 4 is a schematic diagram of the ideal speed point. The five-pointed star in the figure corresponds to the ideal speed point, and the v-goal is the ideal speed. Although the strength levels of different users are different, for the same action, a suitable speed is always similar, and exerting strength at a suitable speed can achieve a good exertion effect and feeling. At this time, the output power of the user is also most likely to peak. Therefore, for a certain action of a user, the user may reach the maximum strength under the ideal strength-exerting speed of the action, which is called the ideal point.

Therefore, it may be considered that the object of the strength test is to make the strength-speed point of the user advance from the lower right to the upper left at a suitable speed within multiple actions and finally fall near the ideal point.

For the first action, the three parameters have a small initial value. After the each round of the test actions are completed, the initial value may be updated according to the data of the action of each round. The f₀ may be small at the beginning to avoid the phenomenon of being unable to pull and gradually increase in the following few tests.

In the embodiment of the present disclosure, determining the measurement parameter at the current round based on the action information at the previous round includes: updating the initial pulling force f₀ during the test action at the m-th round, the initial speed v₀ during the test action at the m-th round, and the proportional parameter k₁ based on the action information of the test action at the (m−1)-th round, wherein m is greater than 1 and less than or equal to 3. In the embodiment of the present disclosure, this method may update the initial pulling force f₀ based on maximum speed and maximum pulling force during the test action at the (m−1)-th round; update v₀ based on a count of completed rounds of the test actions; and update k₁ based on the maximum pulling force during the test action at the (m−1)-th round, f₀, v₀, and the ideal speed.

In the embodiments of the present disclosure, this method may include: update the initial pulling force f₀ during the test action at the m-th round based on a maximum speed vₘₐₓ and a maximum pulling force fₘₐₓ during the test action at the (m−1)-th round; update the initial speed v₀ during the test action at the m-th round based on a count of completed rounds of the test actions; and update the proportional parameter k₁ based on the maximum pulling force fₘₐₓ during the test action at the (m−1)-th round, the initial pulling force f₀ during the test action at the m-th round, the initial speed v₀ during the test action at the m-th round, and an ideal speed. The initial pulling force f₀ during the test action at the m-th round may be updated based on maximum speed vₘₐₓ and maximum pulling force fₘₐₓ during the test action at the (m−1)-th round by the following formula:

$${f}_{0} = {k}_{f} \times {f}_{max}$$

$${k}_{f} = \{ \begin{matrix}0.6 if {v}_{max} is less than or equal to 0.5 \\ 0.5 if {v}_{max} is greater than 0.5 and less than or equal to 0.8 \\ 0.4 if {v}_{max} is greater than 0.8 and less than or equal to 1.2 \\ 0.4 if {v}_{max} is greater than 1.2\end{matrix}$$

wherein the initial speed v₀ during the test action at the m-th round is updated by the following formula:

$${v}_{0} = \{ \begin{matrix}0.3 if T is equal to 1 \\ 0.2 if T i s equal to 2 \\ 0.1 if T is greater than or equal to 3\end{matrix}$$

wherein T is the count of the completed rounds of the test actions.

The proportional parameter k₁ may be updated based on the maximum pulling force fₘₐₓ during the test action at the (m−1)-th round, the initial pulling force f₀ during the test action at the m-th round, the initial speed v₀ during the test action at the m-th round, and an ideal speed by the following formula:

k₁=(fₘₐₓ−f₀)/(goalvel−v₀)

wherein goalvel denotes the ideal speed.

Assuming that the strength of the highest point reached by the user in the action is the strength of the ideal strength-exerting point. If the speed at this point is greater than that of the ideal strength-exerting point, the slope may be increased so that the maximum speed of the user may decrease and approach the ideal strength-exerting point. Assuming that the highest point of the test action of the next round is the ideal strength-exerting point, the slope k₁ (5˜60) of the next round of the test action may be obtained.

After multiple iterations, the strength-speed point may be stabilized near the ideal point, and the above specific parameter values are only for example.

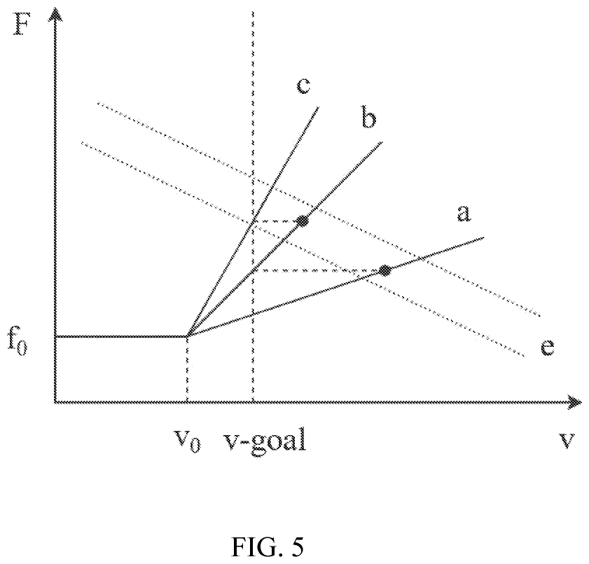

Please refer to FIG. 5, FIG. 5 is a schematic diagram of the F-v curve of actions at three rounds. Assuming that v₀ and f₀ remain unchanged, a, b, and c are the F-v curves of the actions at the three rounds, the solid point is the highest point reached, and e is the range of the strength-speed curve for the user to perform the action. As the load increases, the speed of the action decreases, and gradually approaches the ideal point, the ideal speed of different actions is different.

In some embodiments, the method for strength measurement may also include: determining maximum strength information of the user to be tested based on the action information at the one or more rounds. In some embodiments, the action information may include at least: parameter information corresponding to the test actions. The parameter information may include pulling force, speed, power, etc., corresponding to the test actions. For more instructions for action information, please refer to FIG. 1.

The strength-type intelligent fitness device may need to obtain the strength level of the user to give a suitable training load when the user uses it for the first time. Or strength-type intelligent fitness device may test the maximum strength of the user to change the training load when the strength level of the user changes with training.

The maximum strength of the user may be represented by 1RM; that is, the calculation result is a 1RM value. For different fitness actions, the 1RM values of the same user may be different. Four representative actions (representing different parts) may be chosen as follows: 1. Pull-down (back+upper body); 2. Strength press (shoulder+upper body); 3. Bench press (chest+upper body); 4. Deadlift (core+lower body).

This method usually has 4 types of fitness actions when using the strength-type intelligent fitness device. Therefore, measuring the maximum strengths corresponding to the four types of fitness actions respectively, and setting corresponding strength parameters for exercise when the user is exercising, can ensure the safety and effect of fitness.

“RM” is the abbreviation of “Repetition Maximum,” the literal meaning thereof is “the maximum value of repetitions,” and the free translation is “the maximum count of repetitions.” Combined with the number x, it actually means “the maximum weight that can be repeated for x times” or “the weight that can only be repeated at most x times.”

For example, for a trainer, if a weight of 30 kg is used for biceps curling training, the trainer may only curl up to 6 times continuously and may be completely exhausted. Then for the biceps exercise of the trainer, the 30 kg is 6RM. The 1RM values of the above four actions may represent the strength level of different parts of the user, thereby providing data support for the designation of subsequent personalized load and course.

Because the strength level of the user cannot be obtained before evaluation, a set of evaluation methods that apply to different strength levels is needed. The evaluation method has the following process:

The users perform four standard test actions, and each action is performed more than three times. In an action, the intelligent fitness device automatically sets the next weight based on the strength levels and speed levels of the users each time to adapt to users with different strength levels. The 1RM value of the action of the user is obtained by calculating the action parameter during the action.

In some embodiments, the maximum strength information of the user to be tested may be obtained by calculation based on a plurality of the parameter information corresponding to multiple rounds of the test actions. In some embodiments, action types of a test action at each round during the one or more rounds of the test actions include at least two action types.

In some embodiments, the process of the test actions during the N rounds described in this method specifically includes the following content.

Based on the initial measurement parameter, the user to be tested completes the test action on the strength-type intelligent fitness device for the first round, and the strength-type intelligent fitness device measures and obtains the first maximum pulling force and the first maximum speed of the user to be tested in the first test action, and records the first parameter information of the first test action, and updates the initial measurement parameter based on the first maximum pulling force and the first maximum speed to obtain the first measurement parameter.

Based on the first measurement parameter, the user to be tested completes the test action on the strength-type intelligent fitness device for the second round, and the strength-type intelligent fitness device measures and obtains the second maximum pulling force and the second maximum speed of the user to be tested in the second test action, and records the second parameter information of the second test action and updates the first measurement parameter based on the second maximum pulling force and the second maximum speed to obtain the second measurement parameter.

Based on the (N−2)-th measurement parameter, the user to be tested completes the test action on the strength-type intelligent fitness device for the (N−1)-th time, and the strength-type intelligent fitness device measures and obtains the (N−1)-th maximum pulling force and the (N−1)-th maximum speed of the user to be tested in the (N−1)-th test action, and records the (N−1)-th parameter information of the (N−1)-th test action and updates the (N−2)-th measurement parameter based on the (N−1)-th maximum pulling force and the (N−1)-th maximum speed to obtain the (N−1)-th measurement parameter.

Based on the (N−1)-th measurement parameter, the user to be tested completes the test action on the strength-type intelligent fitness device for the N-th round, and the strength-type intelligent fitness device measures and obtains the N-th maximum pulling force and the N-th maximum speed of the user to be tested in the N-th test action, and records the N-th parameter information of the N test action.

The maximum strength information of the user is obtained based on the first parameter information to the N-th parameter information.

The N in this embodiment may be 3 or 4 or 5. The embodiments of the present disclosure do not perform specific limits, usually being 3-8.

In some embodiments, the method for strength measurement may also include: obtaining at least two maximum strength information of the user to be tested based on the action information corresponding to the test actions of the at least two action types; and determining comprehensive maximum strength information of the user to be tested based on the at least two maximum strength information.

In some embodiments, this method may include four types of test actions. Each type of test action may correspond to maximum strength information. Based on the four maximum strength information, the comprehensive maximum power information of the user is obtained.

In the embodiments of the present disclosure, this method may include obtaining the maximum strength information of the user to be tested by calculating the action information at the one or more rounds based on a multivariate regression model.

In the embodiments of the present disclosure, determining maximum strength information of the user to be tested based on the action information during N rounds of the test actions may include: calculating the maximum strength information of the user to be tested based on a maximum speed, a maximum pulling force, a maximum power, an average speed, and an average power during N rounds of the test actions, wherein N is greater than or equal to 3.

In some embodiments, the maximum strength information of the user to be tested is RM. While the user is performing actions, the actions are counted. For example, one pullout+one retraction, meeting a certain speed rule and a distance rule, can be considered that an action is completed. In the pullout stage of N rounds of actions, the statistics are as follows parameter: the maximum speed during the N rounds of the test actions is denoted as max_vel, the maximum pulling force during the N rounds of the test actions is denoted as max_force, the maximum power during the N rounds of the test actions is denoted as max_power, the average speed during the N rounds of the test actions is denoted as average_vel, the average_power during the N rounds of the test actions is denoted as average_power, k_{max_vel} denotes a multivariate regression coefficient of max_vel, k_{max_force} denotes a multivariate regression coefficient of max_force, k_{max_power} denotes a multivariate regression coefficient of max_power, k_{average_power} denotes a multivariate regression coefficient of average_power, and k_{average_vel} denotes a multivariate regression coefficient of average_vel, wherein, RM=max_vel×k_{max_vel} max_force×k_{max_force} max_power×k_{max_power} average_power×k_{average_power}+average_vel×k_{average_vel}.

One or more embodiments of the present disclosure also provide a device for strength measurement. The device is used to obtain action information at one or more rounds corresponding to one or more rounds of test actions completed by a user to be tested on a strength-type intelligent fitness device, and to update a measurement parameter of the strength-type intelligent fitness device based on the action information at the one or more rounds. In some embodiments, the device is further used to determine a next round of a test action of the strength-type intelligent fitness device based on the updated measurement parameter. For more information about obtaining the action information and updating the measurement parameter, please refer to FIG. 1 and its description.

In some embodiments, the device is further used to determine a measurement parameter at a current round based on an initial measurement parameter, or determine the measurement parameter at the current round based on action information at a previous round. The action information at each round at least includes a maximum pulling force and a maximum speed during each round of the test actions completed by the user to be tested. For more information about determining the measurement parameter at the current round, please refer to FIG. 4 and its description.

In some embodiments, the device for strength measurement is further used to determine maximum strength information of the user to be tested based on the action information at the one or more rounds. For more information about determining the maximum strength information of the user to be tested, please refer to FIG. 5 and its description.

Although preferred embodiments of the present disclosure have been described, additional changes and modifications to these embodiments may occur to technicians skilled in the art once the basic inventive concepts are known. Therefore, the appended claims are intended to be construed to include the preferred embodiment and all changes and modifications that fall within the scope of the present disclosure.

It will be apparent to technicians skilled in the art that various modifications and variations may be made in the present disclosure without departing from the spirit and scope of the disclosure. Thus, provided that these modifications and variations of the present disclosure fall within the scope of the claims of the present disclosure and their equivalents, the present disclosure is also intended to include these modifications and variations.

What is claimed is:

1. A method for strength measurement, comprising:
obtaining action information at one or more rounds corresponding to one or more rounds of test actions completed by a user to be tested on a strength-type intelligent fitness device; and
updating a measurement parameter of the strength-type intelligent fitness device based on the action information at the one or more rounds.

2. The method for strength measurement according to claim 1, wherein the method further comprises:
determining a next round of a test action of the strength-type intelligent fitness device based on the updated measurement parameter; and
the updating the measurement parameter of the strength-type intelligent fitness device based on the action information at the one or more rounds comprising:
determining a measurement parameter at a current round based on an initial measurement parameter; or
determining the measurement parameter at the current round based on action information at a previous round; and
the action information at each round at least comprising: a maximum pulling force and a maximum speed during each round of the test actions completed by the user to be tested.

3. The method for strength measurement according to claim 2, wherein a pulling force of the user to be tested during a test action at the m-th round is F, wherein:
F=f₀+k₁×max(0,vₘ−v₀)
where, f₀ denotes an initial pulling force during the test action at the m-th round, v₀ denotes an initial speed during the test action at the m-th round, vₘ denotes a real-time speed during the test action at the m-th round, k₁ denotes a proportional parameter, and m is greater than or equal to 1 and less than or equal to 3.

4. The method for strength measurement according to claim 2, wherein the determining the measurement parameter at the current round based on the action information at the previous round comprises:
updating the initial pulling force f₀ during the test action at the m-th round, the initial speed v₀ during the test action at the m-th round, and the proportional parameter k₁ based on the action information of the test action at the (m−1)-th round, wherein m is greater than 1 and less than or equal to 3.

5. The method for strength measurement according to claim 4, wherein the determining the measurement parameter at the current round based on the action information at the previous round comprises:
updating the initial pulling force f₀ during the test action at the m-th round based on a maximum speed vₘₐₓ and a maximum pulling force fₘₐₓ during the test action at the (m−1)-th round;
updating the initial speed v₀ during the test action at the m-th round based on a count of completed rounds of the test actions; and
updating the proportional parameter k₁ based on the maximum pulling force fₘₐₓ during the test action at the (m−1)-th round, the initial pulling force f₀ during the test action at the m-th round, the initial speed v₀ during the test action at the m-th round, and an ideal speed.

6. The method for strength measurement according to claim 5, wherein the initial pulling force f₀ during the test action at the m-th round is updated by the following formula:
$${f}_{0} = {k}_{f} \times {f}_{max}$$
$${k}_{f} = \{ \begin{matrix}0.6 if {v}_{max} is less than or equal to 0.5 \\ 0.5 if {v}_{max} is greater than 0.5 and less than or equal to 0.8 \\ 0.4 if {v}_{max} is greater than 0.8 and less than or equal to 1.2 \\ 0.4 if {v}_{max} is greater than 1.2\end{matrix}$$
the initial speed v₀ during the test action at the m-th round is updated by the following formula:
$${v}_{0} = \{ \begin{matrix}0.3 if T is equal to 1 \\ 0.2 if T i s equal to 2 \\ 0.1 if T is greater than or equal to 3\end{matrix}$$
wherein T is the count of the completed rounds of the test actions; and
the proportional parameter k₁ is updated by the following formula:
k₁=(fₘₐₓ−f₀)/(goalvel−v₀)
wherein goalvel denotes the ideal speed.

7. The method for strength measurement according to claim 1, wherein the method further comprises:
determining maximum strength information of the user to be tested based on the action information at the one or more rounds.

8. The method for strength measurement according to claim 7, wherein the determining the maximum strength information of the user to be tested based on the action information at the one or more rounds comprises:
obtaining the maximum strength information of the user to be tested by calculating the action information at the one or more rounds based on a multivariate regression model.

9. The method for strength measurement according to claim 8, wherein the determining the maximum strength information of the user to be tested based on the action information at the one or more rounds comprises:
calculating the maximum strength information of the user to be tested based on a maximum speed, a maximum pulling force, a maximum power, an average speed, and an average power during N rounds of the test actions, wherein N is greater than or equal to 3.

10. The method for strength measurement according to claim 9, wherein the maximum strength information of the user to be tested is denoted as RM, which is determined by the following formula:
RM=max_vel×k_{max_vel} max_force×k_{max_force} max_power×k_{max_power}+average_power×k_{average_power} average_vel×k_{average_vel}
where the maximum speed during the N rounds of the test actions is denoted as max_vel, the maximum pulling force during the N rounds of the test actions is denoted as max_force, the maximum power during the N rounds of the test actions is denoted as max_power, the average speed during the N rounds of the test actions is denoted as average_vel, the average power during the N rounds of the test actions is denoted as average_power, k_{max_vel} denotes a multivariate regression coefficient of max_vel, k_{max_force} denotes a multivariate regression coefficient of max_force, k_{max_power} denotes a multivariate regression coefficient of max_power, k_{average_power} denotes a multivariate regression coefficient of average_power, and k_{average_vel} denotes a multivariate regression coefficient of average_vel.
